(19) United States
(12) Patent Application Publication
(10) Pub. No.: US 2026/0057191 A1
(43) Pub. Date: Feb. 26, 2026

(54) METHOD AND APPARATUS FOR LARGE LANGUAGE MODEL AND INTEGRATION OF LOGIC MATHEMATICAL COMPUTATION

(71) Applicant: Calex LLC, Austin, TX (US)

(72) Inventor: Li-Da Huang, Austin, TX (US)

(21) Appl. No.: 19/309,474

(22) Filed: Aug. 25, 2025

Related U.S. Application Data
(60) Provisional application No. 63/686,798, filed on Aug. 25, 2024.

(51) Int. Cl. G06F 40/40; G06F 8/33; G06F 40/205

(52) U.S. Cl. CPC G06F 40/40; G06F 8/33; G06F 40/205

(57) ABSTRACT

An artificial intelligence system may include a language center, a logic processing unit, and an evolution code generator. In one embodiment, the logic processing unit may include a symbolic processing unit, a combinational logic, and a sequential logic state machine. A natural language query can be transmitted to the symbolic processing unit from the language center to produce symbolic logic expressions, and then transmitted to the combinational logic and the sequential logic state machine to produce optimized symbolic outputs and validated state transitions, which can be sent to the evolution code generator for further optimization. This further optimized language can be transmitted back to the combinational logic to correct logic contradictory, and/or to the sequential logic state machine to trigger for a state transition in the event sequence.

### CROSS-REFERENCE TO RELATED APPLICATIONS

This application claims priority under 35 U.S.C. § 119 (c) to U.S. Provisional Patent Application Ser. No. 63/686,798, filed on Aug. 25, 2024, the entire contents of which are hereby incorporated by reference.

### FIELD OF THE INVENTION

The present invention relates to a method and apparatus for enhancing the performance of a large language model (LLM), and more particularly to a method and apparatus configured to generate feedback loops to enhance the performance of the LLM to generate the natural language representations.

### BACKGROUND OF THE INVENTION

Artificial intelligence systems have undergone rapid evolution over the past two decades. Early approaches focused on rule-based systems and expert logic, which, while deterministic and explainable, lacked adaptability and scalability. With the advent of machine learning and deep learning, statistical models became the dominant paradigm, enabling breakthroughs in speech recognition, computer vision, and natural language processing.

Among these advances, large language models (LLMs) have emerged as particularly powerful tools. Leveraging massive training datasets and transformer-based architectures, LLMs can generate human-like text, perform contextual reasoning, and provide probabilistic answers to a wide variety of tasks. However, their probabilistic nature introduces challenges: outputs can be non-deterministic, inconsistent, or factually inaccurate. This unpredictability makes LLMs unsuitable for mission-critical applications that demand reliability and compliance with strict rules.

Conversely, combinational logic circuits (e.g., Boolean and arithmetic units) and sequential logic circuits (e.g., finite state machines, flip-flop networks) provide deterministic and interpretable operations. Combinational logic instantly computes outputs based on inputs, while sequential logic incorporates memory, enabling ordered decision-making and process continuity. These properties make logic circuits reliable but inflexible in dynamic, evolving environments.

The gap between adaptive but unreliable probabilistic AI and reliable but rigid deterministic logic presents a fundamental limitation. Current hybrid AI approaches typically use logic to filter LLM outputs but fail to allow bidirectional correction, leaving logic circuits static and unresponsive to environmental change.

Therefore, there exists a need for an AI system that combines deterministic logic with probabilistic reasoning in a closed feedback loop, enabling logic processors to be self-corrected and reconfigured under supervision of an LLM while preserving deterministic safeguards.

### SUMMARY OF THE INVENTION

It is an object for the invention to provide a method and apparatus that establishes a continuous dialogue between natural language processing and symbolic reasoning. A language model is used to parse natural language instructions and produce symbolic logic expressions and event sequences. These are then evaluated and optimized by a logic and computational processing unit, which may identify redundancies, resolve contradictions, or enhance efficiency in the symbolic representation. The enhanced symbolic expressions are then fed into an evolution code generator to be further optimized, and then sent back into the language model through a predetermined feedback loop.

It is another object for the invention to provide a device and method for dynamically constructing symbolic logic expressions and event sequences from natural language inputs. A language model, such as a large language model, performs parsing to produce symbolic rules and event structures. These are processed by a logic and computational unit, which evaluates, validates, and optimizes them. The system incorporates hidden states that evolve as a state machine, either statically defined or dynamically constructed.

In one aspect, an artificial intelligence system may include a language center, a logic processing unit, and an evolution code generator. In one embodiment, the logic processing unit may include a symbolic processing unit, a combinational logic, and a sequential logic state machine.

In one embodiment, a symbolic logic in the symbolic processing unit is configured to formalize logical reasoning using symbols and variables to represent statements and relationships, thereby removing ambiguity and allowing for more precise analysis; and the combinational logic is configured to execute operations, which may include Boolean checks, arithmetic validations, rule enforcement.

The sequential logic in the sequential logic state machine depends on not only the current value of the inputs, but also on the past values of the inputs. It is noted that an output of the combinational logic can be a pure function of a present input only, which is in contrast to sequential logic in the sequential logic state machine, in which the output depends not only on the present input but also on the history of the input.

If the symbolic expression produced by the symbolic processing unit is inconsistent or logically contradictory, this can be immediately revealed by the combinational logic, which can invoke a first feedback loop, transmitting error signals back to the symbolic processing unit or language center.

The optimized symbolic outputs and validated state transitions may then be transmitted into the evolution code generator, which in one embodiment is configured to further optimize the output from the logic processing unit. This further optimized output can be transmitted back to the combinational logic to correct logic contradictory, and/or to the sequential logic state machine to trigger for a state transition in the event sequence.

### BRIEF DESCRIPTION OF THE DRAWINGS

FIG. 1 is a flow diagram of an artificial intelligent system in the present invention, which is configured to generate feedback loops to enhance the performance of the large language model (LLM) to generate natural language representations.

FIGS. 2a to 2d are screenshots illustrating an actual use case of the artificial intelligence system in the present invention.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

As used in the description herein and throughout the claims that follow, the meaning of “a”, “an”, and “the” includes reference to the plural unless the context clearly dictates otherwise. Also, as used in the description herein and throughout the claims that follow, the terms “comprise or comprising”, “include or including”, “have or having”, “contain or containing” and the like are to be understood to be open-ended, i.e., to mean including but not limited to. As used in the description herein and throughout the claims that follow, the meaning of “in” includes “in” and “on” unless the context clearly dictates otherwise.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the embodiments. As used herein, the term “and/or” includes any and all combinations of one or more of the associated listed items.

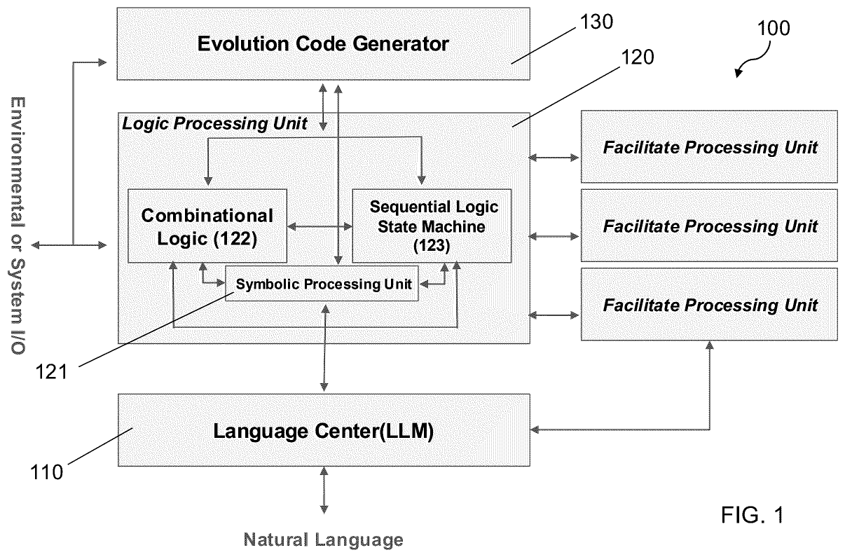

In one aspect, as shown in FIG. 1, an artificial intelligence system 100 may include a language center 110, a logic processing unit 120, and an evolution code generator 130. In one embodiment, the logic processing unit 120 may include a symbolic processing unit 121, a combinational logic 122, and a sequential logic state machine 123.

A symbolic logic in the symbolic processing unit 121 is configured to formalize logical reasoning using symbols and variables to represent statements and relationships, thereby removing ambiguity and allowing for more precise analysis. It is a core component of mathematical logic and computer science, providing a framework for understanding and manipulating logical structures.

The combinational logic 122 is configured to execute operations, which may include Boolean checks, arithmetic validations, and rule enforcement. Boolean logic is a branch of mathematics and computer science that uses variables representing TRUE or FALSE values (often 1 and 0) combined with logical operators like AND, OR, and NOT to evaluate conditions, build databases, design circuits, and refine digital searches. It provides a formal way to reason about statements and is foundational to modern digital technology and programming. For example, we use a switch/button to control the on/off state of an electronic device, which is representative of a Boolean value as the device can only be on or off (True or false, 1 or 0).

An output of the combinational logic 122 can be a pure function of a present input only, which is in contrast to sequential logic in the sequential logic state machine 123, in which the output depends not only on the present input but also on the history of the input. In other words, sequential logic has state (or memory) while combinational logic does not.

More specifically, the sequential logic in the sequential logic state machine 123 depends on not only the current value of the inputs, but also on the past values of the inputs. It relies on a register to store a current state. This current state is the result of a history of inputs, which is a context-dependent decision. Based on this current state and inputs the next state can be found. A familiar example of a device with sequential logic is a television set with “channel up” and “channel down” buttons. Pressing the “up” button gives the television an input telling it to switch to the next channel above the one it is currently receiving.

Still referring to FIG. 1, when a user provides a natural language query, the system 100 processes the input through the language center 110. The language center 110 then transmits the natural language query to the symbolic processing unit 121 to produce symbolic logic expressions that encapsulate the semantic and logical structure of the input, as well as removing ambiguity and allowing for further precise analysis. In one embodiment, these symbolic expressions represent operators, conditions, or event-driven constraints in a formalized structure. In another embodiment, if the structure of the natural language is precise, it can skip the symbolic processing unit 121, and directly be transmitted to the combinational logic 122 and the sequential logic state machine 123.

Combinational logic 122 then evaluates the symbolic expressions by mapping inputs directly to outputs without reliance on prior states. It ensures that every symbolic construct derived from the language model can be deterministically computed, using Boolean operators such as AND, OR, and NOT. For example, an expression like (Condition A AND Condition B) OR (NOT Condition C) is directly resolved by combinational logic gates, either implemented in software or hardware. In this way, the system guarantees that the probabilistic output of the language model is tested against a rigorous logical foundation.

In one embodiment, the combinational logic 122 is configured to optimize the symbolic expressions to minimize redundant expressions and ensure efficient computation through Boolean algebra simplification. By simplifying the logic before passing it further into state machines or hardware synthesis, the combinational logic 122 can be used to reduce computational overhead and accelerate downstream operations.

It is important to note that if the symbolic expression produced by the symbolic processing unit 121 is inconsistent or logically contradictory, this can be immediately revealed by the combinational logic 122, which can invoke a first feedback loop, transmitting error signals back to the symbolic processing unit 121 or language center 110. The language center 110, informed by this feedback, can regenerate or adjust language until they comply with deterministic standards. This first feedback loop be used to improve the accuracy and consistency of the system's reasoning.

While combinational logic 122 ensures immediate and deterministic processing, its outputs also flow into the sequential logic and state machine 123. Sequential logic and state machine 123 introduces temporal elements, maintaining continuity of operation through memory and ordered transitions. Hidden states are tracked and evolved, providing context over time. For example, the output of combinational logic 122 may serve as a trigger for a state transition in the event sequence, enabling the system 100 to respond to ongoing conditions.

The optimized symbolic outputs and validated state transitions may then be transmitted into the evolution code generator 130, which in one embodiment is configured to further optimize the output from the logic processing unit 120. This further optimized output can be transmitted back to the combinational logic 122 to correct logic contradictory, and/or to the sequential logic state machine 123 to trigger for a state transition in the event sequence. In other words, a second feedback loop can be generated by the evolution code generator 130 to modify the output, which is then exported through the language center 110.

In other words, the evolution code generator 130 occupies a distinctive position in the system architecture, functioning as a higher-order optimization unit that sits downstream of both the combinational logic 122 and the sequential logic state machine 123. After the symbolic logic expressions have been evaluated deterministically and simplified by the combinational logic 122, and after the sequential logic state machine 123 has modeled temporal continuity and executed state transitions, the resulting outputs are transmitted into the evolution code generator 130. At this stage, the evolution code generator 130 analyzes these outputs holistically and applies further optimization strategies, producing refinements that transcend the scope of simple Boolean evaluation or state management.

A defining feature of the evolution code generator 130 is its creation of a second feedback loop. While the first feedback loop connects the symbolic processing unit 121 back into the language center 110 for linguistic refinement, the evolution code generator 130 can return its optimized outputs directly to the combinational or sequential logic units. If contradictions are detected, the evolution code generator 130 routes corrected symbolic structures back into the combinational logic 122 for deterministic recomputation. If a new temporal or contextual condition emerges, the evolution code generator 130 can direct updates into the sequential logic state machine 123 to initiate new transitions or modify event sequencing. This recursive mechanism ensures that the system 100 does not merely adjust its natural language responses but actively evolves the structure of its symbolic and logical processes.

The evolution code generator 130 is also designed to accept inputs from the external environment or system-level I/O. In certain embodiments, it receives data streams from sensors, human feedback, or other external devices, and incorporates these inputs directly into its optimization cycle. By responding to environmental changes, the evolution code generator 130 adapts the system's symbolic and sequential logic pathways to real-time conditions. More importantly, in one embodiment, the external environment or system-level I/O can exercise control on the evolution code generator 130 under certain extreme circumstances.

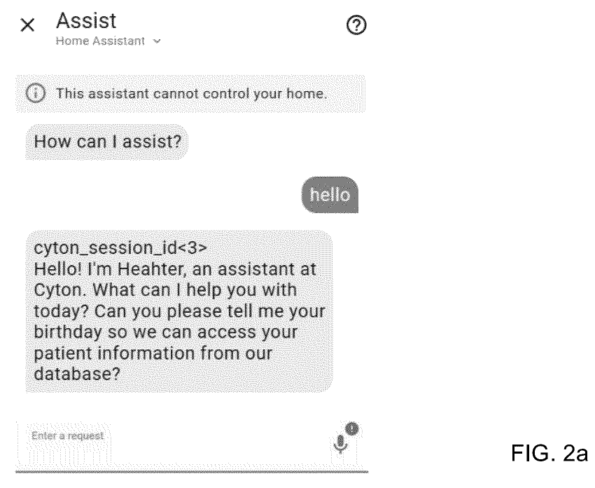

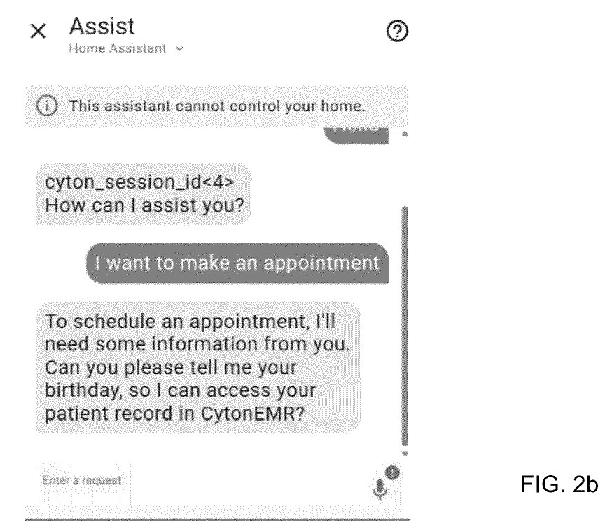

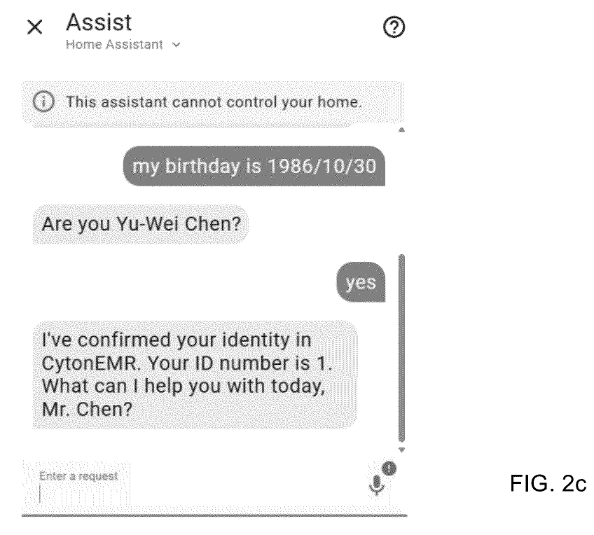

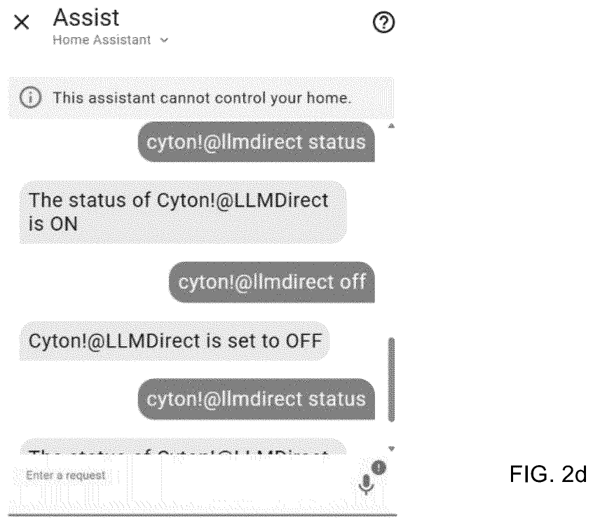

As shown in FIGS. 2a to 2d, the artificial intelligence system 100 is actually used as a receptionist to respond to the inquiries from patients. The language center 110 can interact with the patient from the very beginning with the greetings “Hello” in FIG. 2a, to a complete sentence “I want to make an appointment” in FIG. 2b, which would be sent to the symbolic processing unit 121 to formalize logical reasoning using symbols and variables to represent statements and relationships, and then transmitted to the combinational logic processor 122 and the sequential logic state machine 123 to further process the language to generate a response also shown in FIG. 2b. Similar communications between the patient and the system 100 can be found in FIGS. 2c and 2d.

In an autonomous vehicle, for another example, incoming sensor signals might prompt the evolution code generator 130 to adjust safety logic rules before they are recomputed by the combinational logic processor 122 or applied in the sequential logic state machine 123. In industrial control systems, alarms and sensor warnings may be transmitted into the generator, triggering modified state sequences for safe shutdown. In conversational agents, user sentiment or corrective input could shape the evolution code generator's refinements, producing natural language responses that are both logically sound and contextually sensitive.

Unlike other modules in the system, the evolution code generator 130 operates at a higher layer of abstraction, which not only simplifies or validates logic, but also identifies recurring patterns, re-prioritizes event sequences to enhance future performance. In this way, it contributes not just to immediate correctness, but to the long-term evolution of the system's reasoning strategies.

Once optimization is complete, the evolution code generator 130 outputs its refined results to the language center 110, ensuring that the natural language representation provided to the user is fluent, contextually aligned, and underpinned by validated symbolic logic. This role makes the evolution code generator 130 central to the adaptive and evolving nature of the invention, as it transforms a closed hybrid AI-logic system into a dynamic cybernetic loop that continuously improves through successive iterations.

Having described the invention by the description and illustrations above, it should be understood that these are exemplary of the invention and are not to be considered as limiting. Accordingly, the invention is not to be considered as limited by the foregoing description, but includes any equivalent.

What is claimed is:

1. An artificial intelligence system comprising:
a language center configured to receive natural languages from a user and communicate with the user with natural language outputs generated by the artificial intelligence system;
a logic processing unit comprising:
a symbolic processing unit to parse the natural language received from the language center into symbolic logic expressions;
a combinational logic processor configured to evaluate and simplify said symbolic logic expressions and forward the validated results to either a sequential logic state machine or an evolution code generator;
said sequential logic state machine configured to apply the validated results from the combinational logic processor to event-driven transitions and hidden state evolution, and to provide updated state information to either the combinational logic processor or the evolution code generator; and
said evolution code generator configured to analyze outputs from both the combinational logic processor and the sequential logic state machine, to further optimize symbolic representations, and to generate one or more feedback loops directed back to the combinational logic processor, the sequential logic processor, and the language center,
wherein the symbolic logic expressions and the natural language outputs are iteratively refined through said one or more feedback loops among the language center, the combinational logic processor, the sequential logic state machine, and the evolution code generator.

2. The artificial intelligence system of claim 1, wherein the symbolic logic expressions include operators, conditions, or event-driven constraints in a formalized structure.

3. The artificial intelligence system of claim 1, wherein if a structure of the natural languages is precise, the natural languages are directly transmitted to the combinational logic processor and the sequential logic state machine.

4. The artificial intelligence system of claim 1, wherein the combinational logic processor is configured to optimize the symbolic expressions to minimize redundant expressions and ensure efficient computation through Boolean algebra simplification.

5. The artificial intelligence system of claim 1, wherein if the symbolic expressions produced by the symbolic processing unit are inconsistent or logically contradictory, the combinational logic processor invokes a feedback loop, transmitting error signals back to the symbolic processing unit or the language center.

6. The artificial intelligence system of claim 1, wherein the output of combinational logic serves as a trigger for a state transition in the event sequence, enabling the artificial intelligence system to respond to ongoing conditions.

7. The artificial intelligence system of claim 1, wherein the evolution code generator is configured to further optimize the output from the logic processing unit, which can be transmitted back to the combinational logic to correct logic contradictory, and/or to the sequential logic state machine to trigger for a state transition in the event sequence.

8. The artificial intelligence system of claim 1, wherein the evolution code generator accepts inputs from the external environment or system-level I/O.

9. The artificial intelligence system of claim 8, wherein the evolution code generator receives inputs including data streams from sensors, human feedback, or other external devices, and incorporates these inputs directly into an optimization cycle.

10. The artificial intelligence system of claim 1, wherein the evolution code generator not only simplifies or validates logic, but also identifies recurring patterns, re-prioritizes event sequences to enhance future performance.

11. The artificial intelligence system of claim 1, wherein the symbolic logic expressions can be directly transmitted to the evolution code generator.
